(19) United States
(12) Patent Application Publication
(10) Pub. No.: US 2017/0163371 A1
(43) Pub. Date: Jun. 8, 2017

(54) MULTICARRIER OPTICAL TRANSMITTER, MULTICARRIER OPTICAL RECEIVER, AND MULTICARRIER OPTICAL TRANSMISSION METHOD

(71) Applicant: NEC Corporation, Minato-ku, Tokyo (JP)

(72) Inventors: Tomoyuki HINO, Tokyo (JP); Akio TAJIMA, Tokyo (JP); Hitoshi TAKESHITA, Tokyo (JP); Shinsuke FUJISAWA, Tokyo (JP)

(73) Assignee: NEC Corporation, Minato-ku, Tokyo (JP)

(21) Appl. No.: 15/320,873

(22) PCT Filed: Jun. 19, 2015
(86) PCT No.: PCT/JP2015/003077

§ 371 Date: Dec. 21, 2016

(30) Foreign Application Priority Data
Jun. 25, 2014 (JP) 2014-130226

(51) Int. Cl. H04J 14/08; H04B 10/50

(52) U.S. Cl. CPC H04J 14/08; H04B 10/50

(57) ABSTRACT

It is difficult to build a highly efficient multicarrier optical transmission system because a multicarrier optical transmitter and receiver has limits on the degree of freedom when allocating optical transmission frames to optical subcarriers; therefore, a multicarrier optical transmitter according to an exemplary aspect of the present invention includes transmission-signal generating unit for accommodating a client signal in an optical transmission frame, dividing the optical transmission frame, and outputting divided frames to a plurality of lanes; optical transmission frame multiplex processing unit including a plurality of multiplexing units each of which time-division multiplexing the optical transmission frame inputted from a predetermined input lane included in the plurality of lanes and outputting a single multiplexed optical transmission frame; and optical transmission unit for modulating a plurality of optical subcarriers using a plurality of the multiplexed optical transmission frames respectively and sending a multicarrier optical signal obtained by multiplexing a plurality of modulated optical subcarriers.

### TECHNICAL FIELD

The present invention relates to multicarrier optical transmitters, multicarrier optical receivers, and multicarrier optical transmission methods, in particular, to a multicarrier optical transmitter, a multicarrier optical receiver, and a multicarrier optical transmission method that are used for a backbone optical network.

### BACKGROUND ART

Against a backdrop of the explosive popularization of the Internet, a large-capacity backbone optical network is required. For this reason, an optical transmission network has been developed that employs WDM (wavelength division multiplexing) techniques by which a large-capacity traffic can be transmitted and digital coherent techniques to correct signal distortion with digital signal processing.

In recent years, techniques to transmit even larger-capacity traffic have been required because of the diversification of services provided by networks, the popularization of multifunction terminals, and the like. For example, the service of video contents rapidly increases that is typified by video streaming services. The service data requiring a transmission capacity larger than that for conventional imaging services have made up a large fraction of the traffic of the Internet. In order to deal with the rapid expansion of the transmission capacity within the network due to the above, a technique to maximize the usage efficiency of the existing transmission facilities is required in tandem with additional transmission facilities or devices. As a technique to maximize the usage efficiency of the existing transmission facilities, an elastic optical network that can substantially improve the frequency usage efficiency in an optical fiber has been researched and developed.

The elastic optical network is defined as an optical network that communicates selecting an optimum modulation scheme depending on a transmission distance and a demanded throughput. The elastic optical network makes it possible to transmit signals with a minimum frequency band because an optimum modulation scheme can be selected. It is expected that this substantially improve the frequency usage efficiency. In addition, it is possible to reduce significantly the conventional frequency spacing between channels by introducing frequency slots with finer granularity instead of the fixed grids such as 50 GHz and 100 GHz that have conventionally been used.

The function of selecting an optimum modulation scheme depending on a transmission distance and a demanded throughput and of transmitting accommodated client signals is necessary for an optical transmitter and receiver used in the elastic optical network by which large-volume data can be transmitted with high efficiency. However, there is a problem that it is difficult to achieve the optical transmitter and receiver because the throughput required for the optical transmitter and receiver is more than the pace of performance improvement of electronic circuits. As a technique for solving the problem, there is a technique for parallelizing transmission schemes in the optical transmitter and receiver. That is to say, a multicarrier optical transmission system can solve the above-described problem that transmits in parallel a single client signal with a plurality of optical carriers.

Patent Literature 1 discloses an example of such multicarrier optical transmission system. The related optical transmitter composing the optical transmission system described in Patent Literature 1 includes a transmission signal generation unit, an m:n multiplexing unit, and a transmission optical module. The transmission-signal generating unit divides a frame signal to be transmitted into a plurality of blocks and distributes these blocks to parallel m lanes (m is an integer equal to or greater than 1), and transmits a first signal sequence. The m:n multiplexing unit time-multiplexes bitwise the first signal sequence from the transmission-signal generating unit according to a predetermined multiplexing rule, and rearranges the first signal sequence into a second signal sequence parallelizing n lanes (n is a divisor of m, where m n). The transmission optical module converts the second signal sequence from the m:n multiplexing unit into optical signals respectively.

An m:n multiplexing unit 20 includes a switching unit 21, a multiplex processing unit 22, and a switching unit 23, as illustrated in FIG. 9. The switching unit 21 switches m lanes of an input to each multiplex processing unit 22. The multiplex processing unit 22 multiplexes m lanes of the input into 2, 4 . . . p lanes. The switching unit 23 selects a signal from among signals output from the multiplex processing unit 22 and outputs the signal. The m:n multiplexing unit 20 includes one or more multiplex processing units 22 with a predetermined multiplicity number, and selects and multiplexes the multiplex processing units 22 in the switching units (21, 23) depending on the number of lanes designated by a lane count switching signal from outside.

The frame signal transmitted from the above-mentioned related optical transmitter is an OTU (optical channel transport unit) frame. The OTU frame is a transmission frame configuration in the multiplexing hierarchy of the optical transport network (OTN) standardized by the Telecommunication Standardization Sector of the International Telecommunication Union (ITU-T) (ITU-T Recommendation G.709). Shaping signals into a transmission form of the OTU frame makes it possible to transmit efficiently a diversity of client signals by a wide-area optical network with high reliability.

FIG. 10 illustrates an OTU frame structure standardized by ITU-T. The OTU frame is defined in the ITU-T Recommendation G.709 as a frame structure with 4 rows by 4,080 columns (4×4080=16320 bytes). The frame structure includes three areas of an overhead area (OH area), a payload area, and an error correcting code area (forward error correction: FEC area).

The overhead area (OH area) includes FAS (frame alignment signal), OTU-OH, ODU-OH, and OPU-OH. The FAS is used as bytes to synchronize frames. The OTU-OH area includes bytes used for monitoring signal quality such as section monitoring (SM), and has the function of monitoring bit errors that is referred to as a bit interleaved parity (BIP). Consequently, monitoring optical signals in OTU frame makes it possible to monitor signal qualities that cannot be obtained by the information on optical layers only, such as S/N ratio, input power, and chromatic dispersion. The payload area holds client data.

If the OTU frame is applied to multichannel parallel interfaces, a mechanism is described in ITU-T Recommendation G.709 in which each 16-byte increment of an OUT frame is distributed round robin, to each of a plurality of physical/logical lanes (ITU-T Recommendation G.709, Annex C). Dividing and multiplexing the OTU frame in this manner makes it possible to map a single OTU frame to a plurality of optical carriers.

A related technique is described in Patent Literature 2.

### CITATION LIST

### Patent Literature

[PTL 1] Japanese Unexamined Patent Application Publication No. 2013-126035 (paragraphs [0023] to [0032], FIG. 3 to FIG. 5)

[PTL 2] Japanese Unexamined Patent Application Publication No. 2013-062687

### SUMMARY OF INVENTION

### Technical Problem

As mentioned above, it is possible in the elastic optical network to communicate selecting an optimum modulation scheme depending on a transmission distance and a demanded throughput. This makes the above-mentioned related optical transmitter employ an optical module that can select an arbitrary modulation scheme. Thus, in the multicarrier optical transmission system, an optical module is used in which the modulation scheme, the transmission rate (throughput), and the number of optical subcarriers are variable, that is, an optical module is used that has a high degree of freedom for generating a multicarrier optical signal.

However, since the m:n multiplexing unit 20 included in the above-mentioned related optical transmitter is configured to time-multiplex bitwise the first signal sequence according to a predetermined multiplexing rule, each lane has the same bit rate. Consequently, it is possible in the related optical transmitter to change the number of lanes by selecting a multiplex processing unit 22 corresponding to the multiplicity number, but it is impossible to change the bit rate in each lane. That is to say, the related optical transmitter has a problem that the degree of freedom is limited when allocating optical transmission frames such as OTU frames to optical subcarriers.

As mentioned above, the multicarrier optical transmitter and receiver has limits on the degree of freedom when allocating optical transmission frames to optical subcarriers. Therefore, there has been a problem that it is difficult to build a highly efficient multicarrier optical transmission system utilizing the degree of freedom when generating a multicarrier optical signal.

The object of the present invention is to provide a multicarrier optical transmitter, a multicarrier optical receiver, and a multicarrier optical transmission method that solve the above-mentioned problem. The problem is that it is difficult to build a highly efficient multicarrier optical transmission system because a multicarrier optical transmitter and receiver has limits on the degree of freedom when allocating optical transmission frames to optical subcarriers

### Solution to Problem

A multicarrier optical transmitter according to an exemplary aspect of the present invention includes transmission-signal generating unit for accommodating a client signal in an optical transmission frame, dividing the optical transmission frame, and outputting divided frames to a plurality of lanes; optical transmission frame multiplex processing unit including a plurality of multiplexing units each of which time-division multiplexing the optical transmission frame inputted from a predetermined input lane included in the plurality of lanes and outputting a single multiplexed optical transmission frame; and optical transmission unit for modulating a plurality of optical subcarriers using a plurality of the multiplexed optical transmission frames respectively and sending a multicarrier optical signal obtained by multiplexing a plurality of modulated optical subcarriers.

A multicarrier optical receiver according to an exemplary aspect of the present invention includes optical-signal separating unit for receiving a multicarrier optical signal having multiplexed a plurality of optical subcarriers to transmit an optical transmission frame accommodating a client signal, and separating the multicarrier optical signal into a plurality of optical received signals; optical receiving unit for demodulating each of the plurality of optical received signals and outputting a plurality of demodulated signal sequences; optical transmission frame reconfiguration-processing unit including a plurality of reconfiguring units each of which reconfiguring a predetermined number of optical transmission frame sequences from one of the plurality of demodulated signal sequences and outputting the optical transmission frame sequences; and received signal generating unit for generating the client signal from a plurality of optical transmission frame sequences output from the optical transmission frame reconfiguration-processing unit.

A multicarrier optical transmission method according to an exemplary aspect of the present invention includes accommodating a client signal in an optical transmission frame, dividing the optical transmission frame, and forming a plurality of optical transmission frame sequences; forming a single multiplexed optical transmission frame sequence by time-division multiplexing a predetermined optical transmission frame sequence included in the plurality of optical transmission frame sequences; forming a plurality of multiplexed optical transmission frame sequences by performing a process of forming the multiplexed optical transmission frame sequence with respect to different optical transmission frame sequences; and modulating a plurality of optical subcarriers using the plurality of multiplexed optical transmission frame sequences respectively and sending a multicarrier optical signal having multiplexed a plurality of modulated optical subcarriers.

### Advantageous Effects of Invention

The multicarrier optical transmitter, the multicarrier optical receiver, and the multicarrier optical transmission method according to the present invention makes it possible to build a highly efficient multicarrier optical transmission system because it is possible to increase the degree of freedom when allocating optical transmission frames to optical subcarriers in a multicarrier optical transmitter and receiver.

### BRIEF DESCRIPTION OF DRAWINGS

FIG. 1 is a block diagram illustrating a configuration of a multicarrier optical transmitter in accordance with a first exemplary embodiment of the present invention.

FIG. 2 is a block diagram illustrating a configuration of an optical transmission frame multiplex processing unit included in the multicarrier optical transmitter in accordance with the first exemplary embodiment of the present invention.

FIG. 3 is a block diagram illustrating a configuration of the optical transmission frame multiplex processing unit to describe the operation of the multicarrier optical transmitter in accordance with the first exemplary embodiment of the present invention.

FIG. 4 is a block diagram illustrating a configuration of a multicarrier optical receiver in accordance with a second exemplary embodiment of the present invention.

FIG. 5 is a block diagram illustrating a configuration of an optical transmission frame reconfiguration-processing unit included in the multicarrier optical receiver in accordance with the second exemplary embodiment of the present invention.

FIG. 6 is a block diagram illustrating a configuration before a failure of an optical transmission frame multiplex processing unit to describe a multicarrier optical transmission method in accordance with a third exemplary embodiment of the present invention.

FIG. 7 is a block diagram illustrating a configuration after a failure of the optical transmission frame multiplex processing unit to describe the multicarrier optical transmission method in accordance with the third exemplary embodiment of the present invention.

FIG. 8 is a block diagram illustrating a configuration of a multiplex processing unit included in a multicarrier optical transmitter used in the third exemplary embodiment of the present invention.

FIG. 9 is a block diagram illustrating a configuration of an m:n multiplexing unit included in the related optical transmitter.

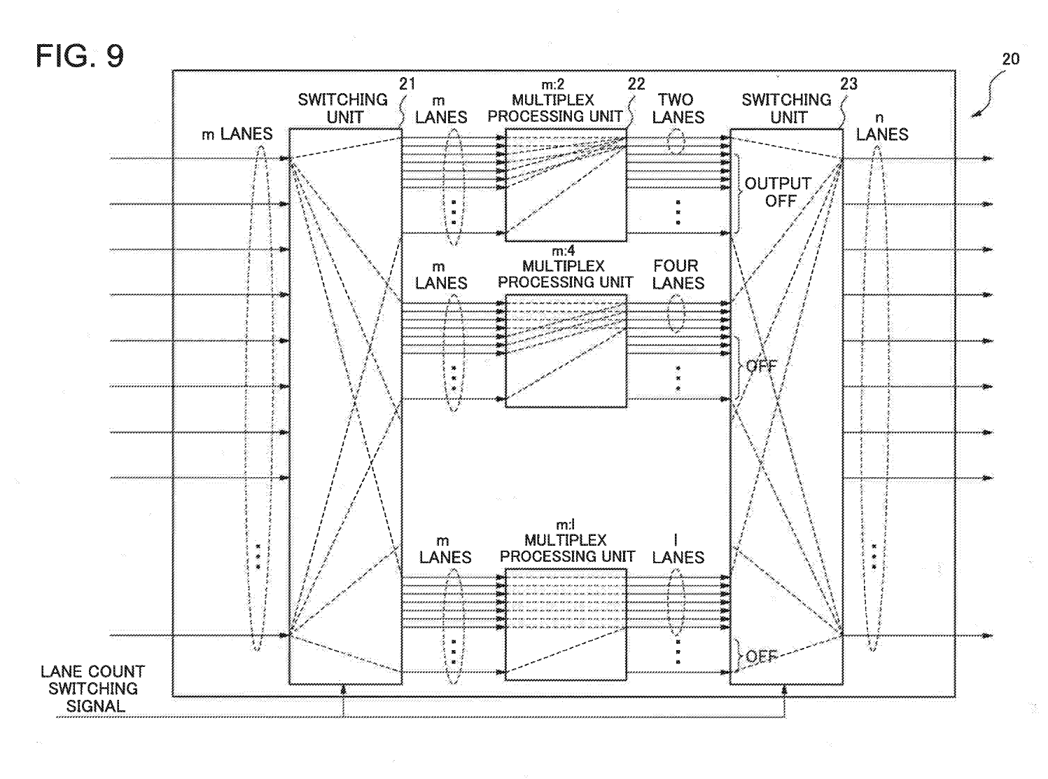

FIG. 10 is a diagram illustrating an OTU frame structure standardized by the ITU-T.

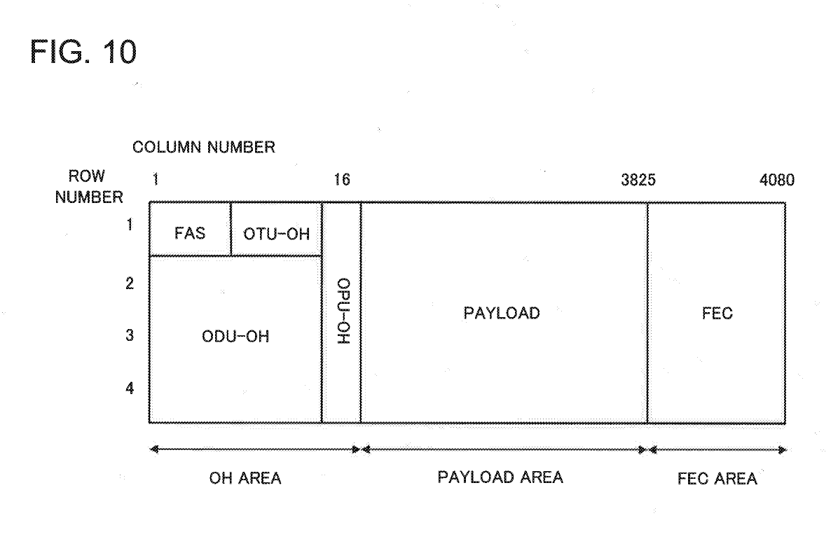

### DESCRIPTION OF EMBODIMENTS

Exemplary embodiments of the present invention will be described below with reference to the drawings.

### A First Exemplary Embodiment

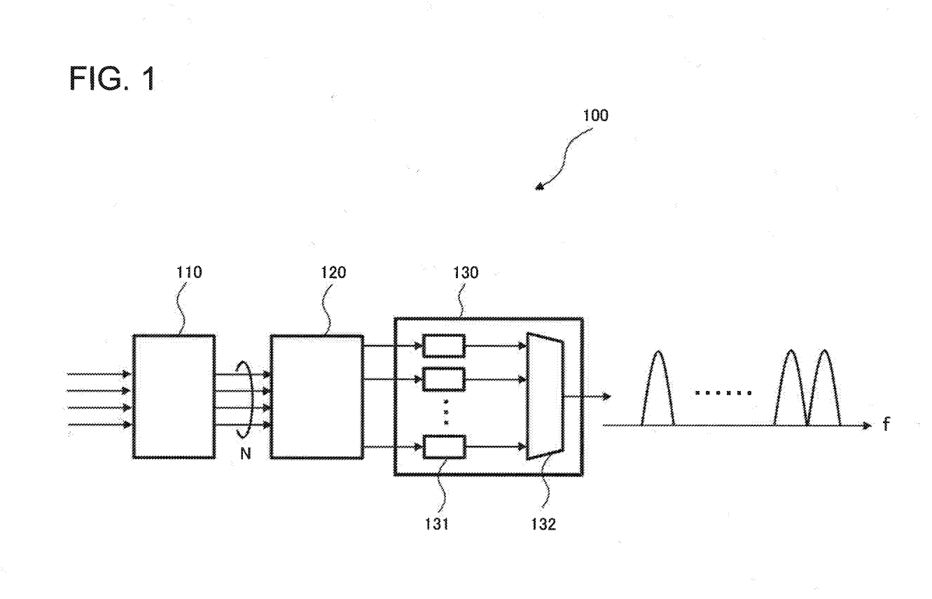

FIG. 1 is a block diagram illustrating a configuration of a multicarrier optical transmitter 100 in accordance with a first exemplary embodiment of the present invention. The multicarrier optical transmitter 100 includes a transmission-signal generating unit 110, an optical transmission frame multiplex processing unit 120, and an optical transmission unit 130.

The transmission-signal generating unit 110 accommodates a client signal in an optical transmission frame, divides the optical transmission frame, and outputs divided frames to a plurality of (N) lanes. The optical transmission frame multiplex processing unit 120 includes a plurality of multiplexing units each of which time-division multiplexes the optical transmission frame inputted from a predetermined input lane included in the plurality of lanes and outputs a single multiplexed optical transmission frame. The optical transmission unit 130 modulates a plurality of optical subcarriers using a plurality of multiplexed optical transmission frames respectively and sends a multicarrier optical signal obtained by multiplexing a plurality of modulated optical subcarriers. The optical transmission unit 130 can include an optical module unit 131 configured to modulate each of the optical subcarriers, and an optical signal multiplexing unit 132 configured to multiplex a plurality of modulated optical subcarriers.

The above-mentioned optical transmission frame is typically an OTU (Optical Channel Transport Unit) frame that is standardized by ITU-T Recommendation G.709. In this case, the transmission-signal generating unit 110 receives client data, forms at least one OTU frame from the client data, and outputs the OTU frame to N output lanes. The N outputs are connected to the optical transmission frame multiplex processing unit 120.

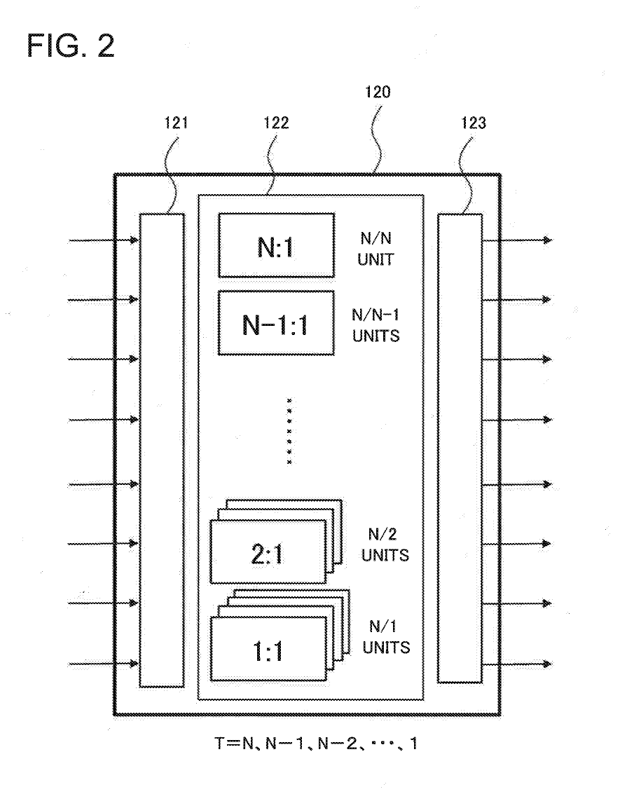

FIG. 2 illustrates a configuration of the optical transmission frame multiplex processing unit 120. The optical transmission frame multiplex processing unit 120 can be configured to include an input switching unit 121, a multiplex processing unit 122, and an output-switching unit 123.

The input switching unit 121 connects the transmission-signal generating unit 110 to the multiplex processing unit 122. That is to say, N inputs from the transmission-signal generating unit 110 to form an OTU frame are switched and connected to an arbitrary input port of the multiplex processing unit 122. The output-switching unit 123 connects the multiplex processing unit 122 to the optical transmission unit 130.

The multiplex processing unit 122 includes a plurality of multiplexing units. The plurality of multiplexing units differ in the number of input lanes. If T represents the number of input lanes, T=N, N−1, N−2 . . . 1. That is to say, the plurality of multiplexing units differs in frame multiplexing ratio T:1 (T=N, N−1, N−2, . . . , 1). For example, a multiplexing unit having a multiplexing ratio of N:1 multiplexes N-inputs OTU frames into one output, and a multiplexing unit having a multiplexing ratio of 2:1 multiplexes two-inputs OTU frames into one output.

The multiplex processing unit 122 include the multiplexing units, the number of which depends on the number of input lanes, with respect to each number of input lanes. More specifically, the number of multiplexing units can be equal to or larger than a value of the integer portion of the quotient obtained by dividing the number (N) of a plurality of lanes output from the transmission-signal generating unit 110 by the number (T) of the input lanes. That is to say, each number of multiplexing units depends on the number N of the lanes and an arbitrary multiplexing ratio T:1 (T=N, N−1, N−2, . . . , 1), and it can be configured to include the multiplexing units with the number equal to or larger than floor(N/T) with respect to each multiplexing ratio. Here, “floor” represents a function that inputs a real value given by an argument and outputs a maximum integer value equal to or smaller than the real value. The configuration makes it possible to multiplex N-inputs OTU frames into one output by only a multiplexing unit having a multiplexing ratio T:1. For example, if the number of input lanes is equal to eight (N=8), at least four multiplexing units having a multiplexing ratio of 2:1 may be included.

The output-switching unit 123 connects, by switching, a plurality of outputs from the multiplex processing unit 122 to each optical module unit 131 included in the optical transmission unit 130.

A plurality of multiplexing units having different multiplexing ratios included in the multiplex processing unit 122 are selectively connected to the input switching unit 121 and the output-switching unit 123 depending on the throughput necessary for each optical module unit 131. That is to say, the multiplexing units are selectively connected so that the multiplexing ratio may be decreased for a lane having a smaller throughput and it may be increased for a lane having a larger throughput.

The multicarrier optical transmitter 100 in accordance with the present exemplary embodiment can be configured to include further a control unit, which selects a multiplexing unit connected to the transmission-signal generating unit 110 and the optical transmission unit 130 respectively, depending on setting conditions. The setting conditions include at least the number of optical subcarriers and a processing speed with respect to each optical subcarrier. The control unit selects a multiplexing unit so that the number of multiplexing units may correspond to the number of optical subcarriers and the processing speed of the multiplexed optical transmission frames may correspond to the processing speed of the optical subcarriers. In this case, the control unit can be configured to include a storage unit that stores the above-mentioned setting conditions in advance. The present exemplary embodiment is not limited to this, and the control unit may obtain the setting conditions from an optical network controller that controls an optical network through which the multicarrier optical signals propagate.

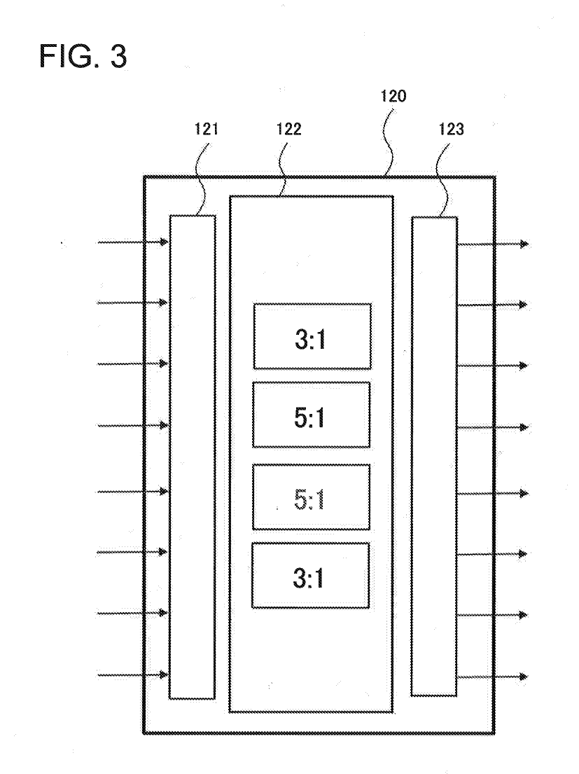

Next, the operation of the optical transmission frame multiplex processing unit 120 included in the multicarrier optical transmitter 100 in accordance with the present exemplary embodiment will be described in more detail with reference to FIG. 3. FIG. 3 is a block diagram illustrating a configuration of the optical transmission frame multiplex processing unit 120, and only multiplexing units connected to the input switching unit 121 and the output-switching unit 123 are illustrated in the figure. Other configurations are the same as those illustrated in FIG. 2.

The operation of the optical transmission frame multiplex processing unit 120 will be described hereinafter based on the following concrete numerical examples. The client data capacity is equal to 400 Gbps, and the throughput per lane is equal to 25 Gbps. The number of optical subcarriers is four, the number of optical module units as line-side interfaces is four, and the number of optical subcarriers per optical module unit is one.

In this case, the client data with 400 Gbps are connected to the transmission-signal generating unit 110 and undergoes an OTU framing process. Then the processed data are divided into 16 parallel lanes having a throughput of 25 Gbps per lane and connected to the optical transmission frame multiplex processing unit 120.

The optical transmission frame multiplex processing unit 120 includes a multiplex processing unit 122 including multiplexing units each of which has a multiplexing ratio T:1 (T=16, 15, 14, . . . , 2, 1). The number of multiplexing units included is equal to or larger than floor (N/T) with respect to each multiplexing ratio. Consequently, the multiplex processing unit 122 includes one multiplexing unit having a multiplexing ratio of 16:1, four multiplexing units having a multiplexing ratio of 4:1, and five multiplexing units having a multiplexing ratio of 3:1, for example.

If the client data with 400 Gbps are transmitted by four optical subcarriers, the transmission-signal generating unit 110 outputs the OTU frame dividing it into 16 lanes, assuming the throughput per lane to be equal to 25 Gbps. The optical transmission frame multiplex processing unit 120 converts 16 lanes into 4 lanes and the optical transmission unit 130 transmits them by four optical subcarriers at a throughput of 100 Gbps per optical subcarrier.

Optical subcarriers situated at the farthest both ends of a plurality of optical subcarriers successively arranged on the frequency axis are most influenced by band narrowing due to a wavelength filter or adjacent channels. Consequently, they are susceptible to signal quality deterioration due to transmission. To reduce the influence, signals can be transmitted by using four optical subcarriers that have throughputs of 75 Gbps, 125 Gbps, 125 Gbps, and 75 Gbps starting from the leftmost optical subcarrier, for example.

If this is the case, the optical transmission frame multiplex processing unit 120 selectively uses four multiplexing units including two types of multiplexing units. That is to say, as illustrated in FIG. 3, the optical transmission frame multiplex processing unit 120 is configured to include two multiplexing units having a multiplexing ratio of 3:1 to generate a throughput of 75 Gbps, and two multiplexing units having a multiplexing ratio of 5:1 to generate a throughput of 125 Gbps. At this time, the input switching unit 121 in the optical transmission frame multiplex processing unit 120 connects 16-lanes inputs to selected four multiplexing units including two types: (three-input, one-output), (three-input, one-output), (five-input, one-output), and (five-input, one-output). The OTU frame (multiplexed optical transmission frame) multiplexed in the multiplex processing unit 122 is connected to each optical module unit 131 through the output-switching unit 123 and mapped onto each optical subcarrier by each optical module unit 131.

The configuration of the multicarrier optical transmitter 100 in accordance with the present exemplary embodiment is not limited by the above-described numerical examples.

As mentioned above, the multicarrier optical transmitter in accordance with the present exemplary embodiment can form multiplexed optical transmission frames corresponding to the number of optical subcarriers and the processing speed for each optical subcarrier. Consequently, it is possible to increase the degree of freedom when allocating optical transmission frames to optical subcarriers, which makes it possible to build a highly efficient multicarrier optical transmission system.

### A Second Exemplary Embodiment

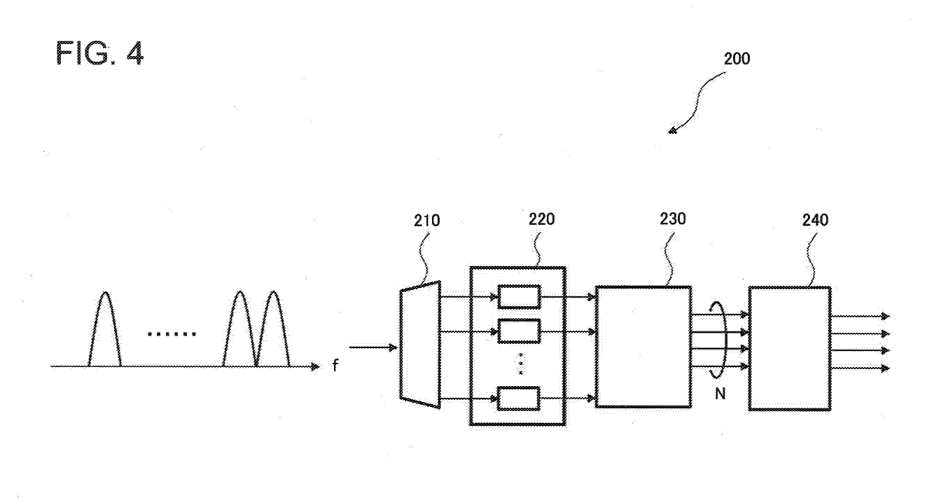

Next, a second exemplary embodiment of the present invention will be described. FIG. 4 illustrates a configuration of a multicarrier optical receiver in accordance with the present exemplary embodiment. A multicarrier optical receiver 200 in accordance with the present exemplary embodiment composes a multicarrier optical transmission system in combination with the multicarrier optical transmitter 100 in accordance with the first exemplary embodiment.

The multicarrier optical receiver 200 includes an optical-signal separating unit 210, an optical receiving unit 220, an optical transmission frame reconfiguration-processing unit 230, and a received signal generating unit 240.

The optical-signal separating unit 210 receives a multicarrier optical signal having multiplexed a plurality of optical subcarriers to transmit an optical transmission frame accommodating a client signal, and separates the multicarrier optical signal into a plurality of optical received signals. The optical receiving unit 220 demodulates each of the plurality of optical received signals and outputs a plurality of demodulated signal sequences. The optical transmission frame reconfiguration-processing unit 230 includes a plurality of reconfiguring units each of which reconfigures a predetermined number of optical transmission frame sequences from one of the plurality of demodulated signal sequences and outputs the optical transmission frame sequences. The received signal generating unit 240 generates the client signal from a plurality of optical transmission frame sequences (N) that the optical transmission frame reconfiguration-processing unit 230 outputs.

The above-mentioned optical transmission frame is typically an OTU (Optical Channel Transport Unit) frame that is standardized by ITU-T Recommendation G.709.

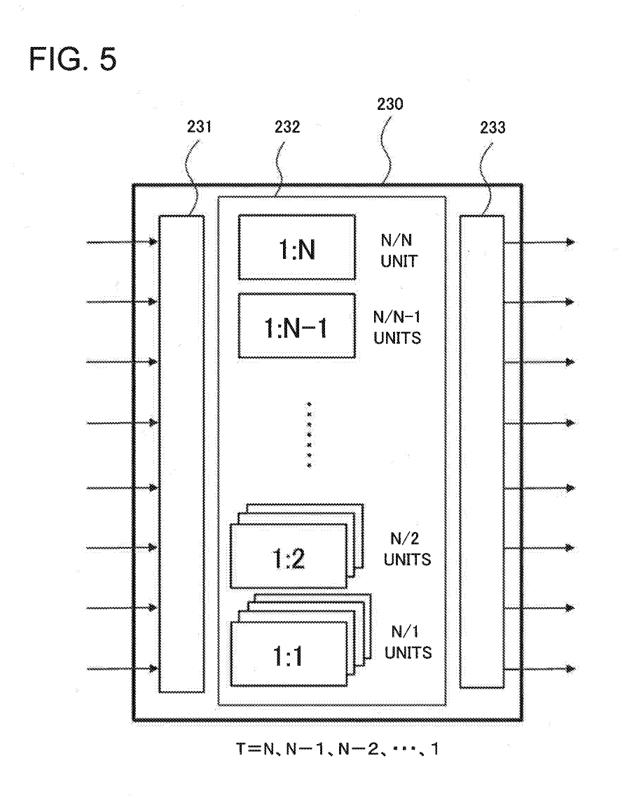

FIG. 5 illustrates a configuration of the optical transmission frame reconfiguration-processing unit 230. The optical transmission frame reconfiguration-processing unit 230 can be configured to include an input switching unit 231, a reconfiguration-processing unit 232, and an output-switching unit 233. The input switching unit 231 connects the optical receiving unit 220 to the reconfiguration-processing unit 232. The output-switching unit 233 connects the reconfiguration-processing unit 232 to the received signal generating unit 240.

The reconfiguration-processing unit 232 includes a plurality of reconfiguring units. The plurality of reconfiguring units differ in the number of optical transmission frame sequences to be output. That is to say, if the number of optical transmission frame sequences to be output is represented by T=N, N−1, N−2 . . . 1, a frame reconfiguring ratio 1:T is different from each other. Here, “N” represents the total number of optical transmission frame sequences that the optical transmission frame reconfiguration-processing unit 230 outputs. For example, a reconfiguring unit having a frame reconfiguring ratio of 1:N reconfigures a one-input OTU frame into N outputs.

The optical transmission frame reconfiguration-processing unit 230 can be configured to include the reconfiguring units, the number of which depends on the number of optical transmission frame sequences, with respect to each number of optical transmission frame sequences. More specifically, taking the numerical values described in the first exemplary embodiment for example, the optical transmission frame reconfiguration-processing unit 230 can be configured to include four reconfiguring units with two types: (one-input, three-output), (one-input, three-output), (one-input, five-output), and (one-input, five-output).

As mentioned above, the multicarrier optical receiver in accordance with the present exemplary embodiment can reconfigure optical transmission frames corresponding to the number of optical subcarriers and the processing speed for each optical subcarrier. Consequently, it is possible to increase the degree of freedom when allocating optical transmission frames to optical subcarriers, which makes it possible to build a highly efficient multicarrier optical transmission system.

### A Third Exemplary Embodiment

Next, a third exemplary embodiment of the present invention will be described. In the third exemplary embodiment, a multicarrier optical transmission method will be described.

In the multicarrier optical transmission method in accordance with the present exemplary embodiment, first, a client signal is accommodated in an optical transmission frame, the optical transmission frame is divided, and a plurality of optical transmission frame sequences are formed. A single multiplexed optical transmission frame sequence is formed by time-division multiplexing a predetermined optical transmission frame sequence included in the plurality of optical transmission frame sequences. A plurality of multiplexed optical transmission frame sequences are formed by performing the process of forming the multiplexed optical transmission frame sequence with respect to different optical transmission frame sequences. After that, a plurality of optical subcarriers are modulated using the plurality of multiplexed optical transmission frame sequences respectively, and a multicarrier optical signal having multiplexed the plurality of modulated optical subcarriers is sent.

Here, when forming the plurality of multiplexed optical transmission frame sequences mentioned above, a configuration can be used in which the number of multiplexed optical transmission frame sequences corresponds to the number of optical subcarriers, and the processing speed of the multiplexed optical transmission frame sequences corresponds to the processing speed of the optical subcarriers.

As described above, according to the multicarrier optical transmission method of the present exemplary embodiment, it is possible to form the multiplexed optical transmission frame corresponding to the number of optical subcarriers and the processing speed of each optical subcarrier. Therefore, it becomes possible to build a highly efficient multicarrier optical transmission system because it is possible to increase the degree of freedom when allocating optical transmission frames to optical subcarriers.

Next, the multicarrier optical transmission method of the present exemplary embodiment will be described in more detail taking for example a case where the multicarrier optical transmitter 100 in accordance with the first exemplary embodiment is used.

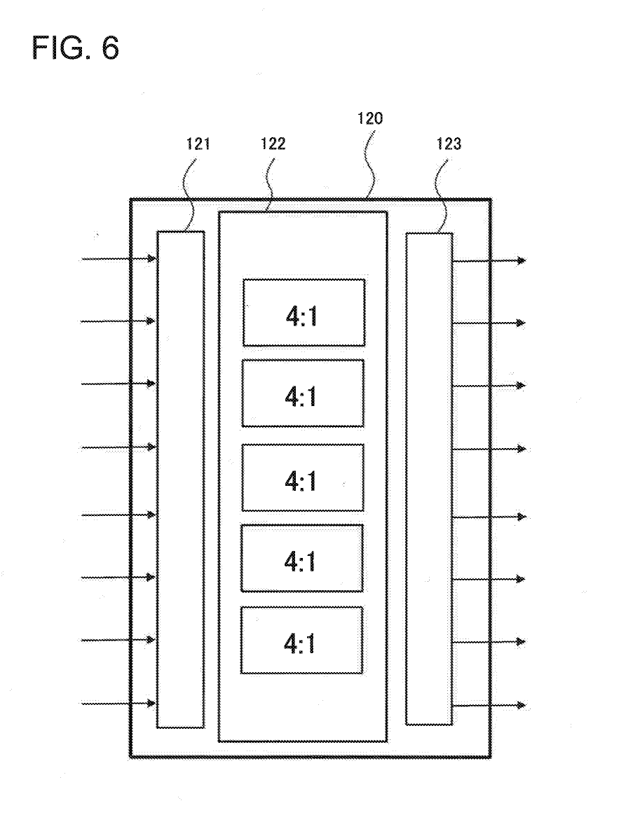

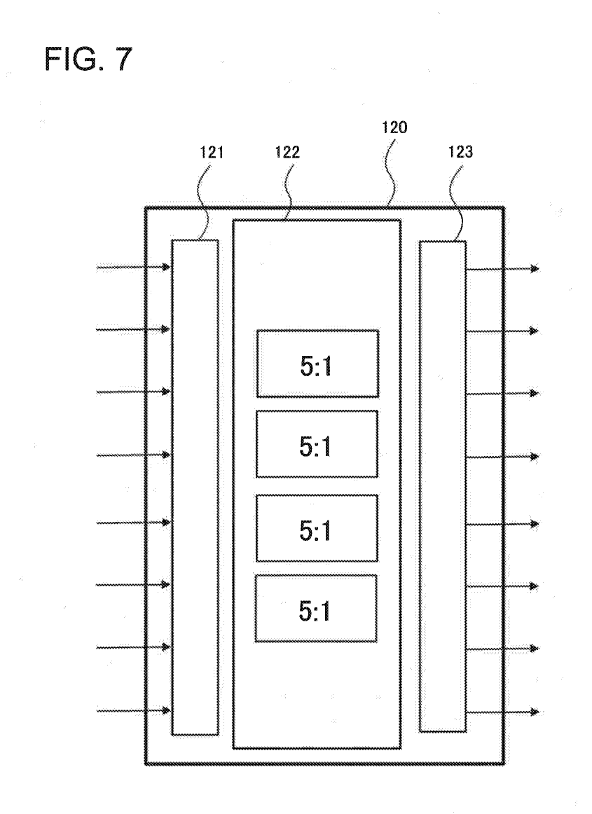

The present exemplary embodiment will be described taking for example a case where the throughput (processing speed) of each optical subcarrier is dynamically changed when the number of optical subcarriers available varies due to a failure. FIG. 6 and FIG. 7 illustrate configurations of the optical transmission frame multiplex processing unit 120 in the multicarrier optical transmitter 100 in accordance with the first exemplary embodiment that is used in the present exemplary embodiment. FIG. 6 illustrates a configuration of the optical transmission frame multiplex processing unit 120 before the occurrence of a failure, and FIG. 7 illustrates a configuration of the optical transmission frame multiplex processing unit 120 after the occurrence of a failure. FIG. 6 and FIG. 7 illustrate only multiplexing units that are connected to the input switching unit 121 and the output-switching unit 123 and used.

The multicarrier optical transmission method in accordance with the present exemplary embodiment will be described hereinafter based on the following concrete numerical examples. The client data capacity is equal to 500 Gbps and the throughput per lane is equal to 25 Gbps. The number of optical subcarriers is five before the occurrence of a failure and four after the occurrence of a failure. The number of optical module units as line-side interfaces is five before the occurrence of a failure and four after the occurrence of a failure. The number of optical subcarriers per optical module unit is one.

In this case, the client data with 500 Gbps are transmitted using five optical subcarriers before the occurrence of a failure. At this time, since the throughput of a single optical subcarrier is equal to 100 Gbps, the optical transmission frame multiplex processing unit 120 uses five 4:1 multiplexing units as illustrated in FIG. 6.

It is assumed that one of the five optical subcarriers has become unavailable due to the occurrence of a failure such as a hardware fault in the optical module unit 131. At this time, the optical transmission frame multiplex processing unit 120 changes the multiplexing unit to be used before and after the occurrence of the failure so that the client data having a throughput of 500 Gbps may be transmitted by the remaining four subcarriers. More specifically, the configuration in which five 4:1 multiplexing units are used (FIG. 6) before the occurrence of the failure is dynamically changed to the configuration in which only four 5:1 multiplexing units are used (FIG. 7). At this time, the throughput per optical subcarrier changes from 100 Gbps to 125 Gbps. The above-mentioned numerical examples are used for purposes of illustration and not limitation.

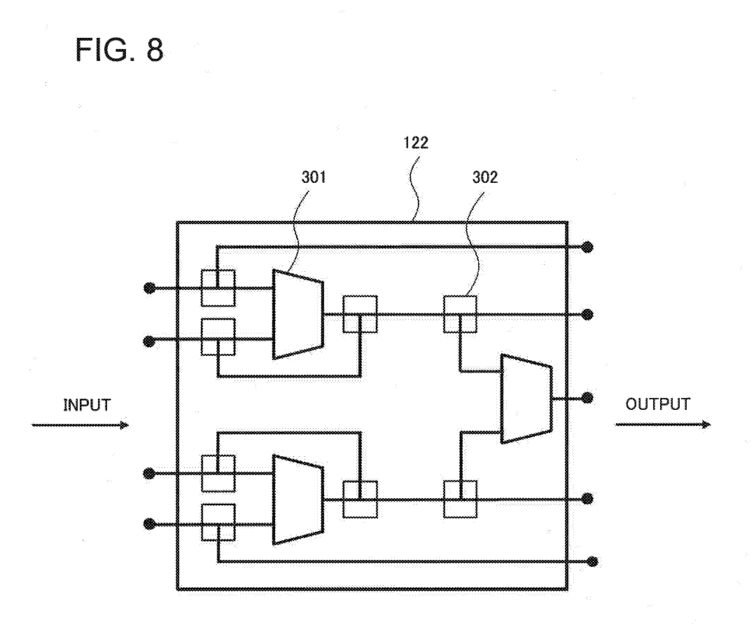

The multiplex processing unit 122 can be configured as illustrated in FIG. 8. That is to say, a configuration can be used in which a plurality of two-input, one-output multiplexing circuits 301 and switch circuits 302 with small port count are combined. This makes it possible to configure a multiplex processing unit 122 including one (four-input, one-output) multiplexing unit, one (three-input, one-output) multiplexing unit, and two (two-input, one-output) multiplexing units, or four (one-input, one-output) multiplexing units. That is to say, it becomes possible to make, by a single circuit configuration, the multiplex processing unit 122 in which four multiplexing ratios can be selected. As a result, it is possible to prevent the circuit size of the multiplex processing unit 122 from increasing.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2014-130226, filed on Jun. 25, 2014, the disclosure of which is incorporated herein in its entirety by reference.

### REFERENCE SIGNS LIST

100 multicarrier optical transmitter
110 transmission-signal generating unit
120 optical transmission frame multiplex processing unit
121 input switching unit
122 multiplex processing unit
123 output-switching unit
130 optical transmission unit
131 optical module unit
132 optical signal multiplexing unit
200 multicarrier optical receiver
210 optical-signal separating unit
220 optical receiving unit
230 optical transmission frame reconfiguration-processing unit
231 input switching unit
232 reconfiguration-processing unit
233 output-switching unit
240 received signal generating unit
301 two-input, one-output multiplexing circuit
302 switch circuit
m:n multiplexing unit
21, 23 switching unit
22 multiplex processing unit

What is claimed is:

1. A multicarrier optical transmitter, comprising:
a transmission-signal generating unit configured to accommodate a client signal in an optical transmission frame, divide the optical transmission frame, and output divided frames to a plurality of lanes;
an optical transmission frame multiplex processing unit including a plurality of multiplexing units each of which time-division multiplexing the optical transmission frame inputted from a predetermined input lane included in the plurality of lanes and outputting a single multiplexed optical transmission frame; and
an optical transmission unit configured to modulate a plurality of optical subcarriers using a plurality of the multiplexed optical transmission frames respectively and sending a multicarrier optical signal obtained by multiplexing a plurality of modulated optical subcarriers.

2. The multicarrier optical transmitter according to claim 1,
wherein the optical transmission frame multiplex processing unit includes the plurality of multiplexing units that differ in number of input lanes.

3. The multicarrier optical transmitter according to claim 1,
wherein the optical transmission frame multiplex processing unit includes the multiplexing units, number of which depends on number of input lanes, with respect to each number of input lanes.

4. The multicarrier optical transmitter according to claim 3,
wherein the number of multiplexing units is not less than a value of an integer portion of a quotient obtained by dividing number of a plurality of lanes output from the transmission signal generation unit by the number of input lanes.

5. The multicarrier optical transmitter according to claim 1, further comprising a control unit,
wherein the control unit selects the multiplexing units connected to the transmission signal generation unit and the optical transmission unit respectively, depending on setting conditions.

6. The multicarrier optical transmitter according to claim 5,
wherein the setting conditions include at least number of optical subcarriers and a processing speed with respect to each of the optical subcarriers, and
the control unit selects the multiplexing unit so that number of multiplexing units may correspond to the number of optical subcarriers and a processing speed of the multiplexed optical transmission frames may correspond to the processing speed of the optical subcarriers.

7. The multicarrier optical transmitter according to claim 5,
wherein the control unit includes a unit configured to store the setting conditions in advance.

8. The multicarrier optical transmitter according to claim 5,
wherein the control unit obtains the setting conditions from an optical network control unit configured to control an optical network through which the multicarrier optical signal propagates.

9. The multicarrier optical transmitter according to claim 1,
wherein the optical transmission frame multiplex processing unit includes
a multiplex processing unit including the plurality of multiplexing units,
an input switching unit configured to connect the transmission-signal generation unit to the multiplex processing unit; and
an output-switching unit configured to connect the multiplex processing unit to the optical transmission unit.

10. A multicarrier optical receiver, comprising:
an optical-signal separating unit configured to receive a multicarrier optical signal having multiplexed a plurality of optical subcarriers to transmit an optical transmission frame accommodating a client signal, and separate the multicarrier optical signal into a plurality of optical received signals;
an optical receiving unit configured to demodulate each of the plurality of optical received signals and output a plurality of demodulated signal sequences;
an optical transmission frame reconfiguration-processing unit including a plurality of reconfiguring units each of which reconfiguring a predetermined number of optical transmission frame sequences from one of the plurality of demodulated signal sequences and outputting the optical transmission frame sequences; and
a received signal generating unit configured to generate the client signal from a plurality of optical transmission frame sequences output from the optical transmission frame reconfiguration-processing unit.

11. The multicarrier optical receiver according to claim 10,
wherein the optical transmission frame reconfiguration-processing unit includes the plurality of reconfiguring units that differ in number of optical transmission frame sequences.

12. The multicarrier optical receiver according to claim 10,
wherein the optical transmission frame reconfiguration-processing unit includes the reconfiguring units, number of which depends on number of optical transmission frame sequences, with respect to each number of optical transmission frame sequences.

13. The multicarrier optical receiver according to claim 10,
wherein the optical transmission frame reconfiguration-processing unit includes
a reconfiguration-processing unit including the plurality of reconfiguring units;
an input switching unit configured to connect the optical receiving unit to the reconfiguration-processing unit, and
an output-switching unit configured to connect the reconfiguration-processing unit to the received signal generating unit.

14. A multicarrier optical transmission system, comprising:
the multicarrier optical transmitter according to claim 1, and
a multicarrier optical receiver including
an optical-signal separating unit configured to receive a multicarrier optical signal having multiplexed a plurality of optical subcarriers to transmit an optical transmission frame accommodating a client signal, and separate the multicarrier optical signal into a plurality of optical received signals;
an optical receiving unit configured to demodulate each of the plurality of optical received signals and output a plurality of demodulated signal sequences;
an optical transmission frame reconfiguration-processing unit including a plurality of reconfiguring units each of which reconfiguring a predetermined number of optical transmission frame sequences from one of the plurality of demodulated signal sequences and outputting the optical transmission frame sequences; and
a received signal generating unit configured to generate the client signal from a plurality of optical transmission frame sequences output from the optical transmission frame reconfiguration-processing unit.

15. The multicarrier optical transmission system according to claim 14,
wherein the multicarrier optical receiver receives the multicarrier optical signal sent from the multicarrier optical transmitter.

16. A multicarrier optical transmission method, comprising:
accommodating a client signal in an optical transmission frame, dividing the optical transmission frame, and forming a plurality of optical transmission frame sequences;
forming a single multiplexed optical transmission frame sequence by time-division multiplexing a predetermined optical transmission frame sequence included in the plurality of optical transmission frame sequences;
forming a plurality of multiplexed optical transmission frame sequences by performing a process of forming the multiplexed optical transmission frame sequence with respect to different optical transmission frame sequences; and
modulating a plurality of optical subcarriers using the plurality of multiplexed optical transmission frame sequences respectively and sending a multicarrier optical signal having multiplexed a plurality of modulated optical subcarriers.

17. The multicarrier optical transmission method according to claim 16,
wherein the forming of the plurality of multiplexed optical transmission frame sequences includes making number of multiplexed optical transmission frame sequences correspond to number of optical subcarriers and making a processing speed of the multiplexed optical transmission frame sequences correspond to a processing speed of the optical subcarriers.

18. The multicarrier optical transmitter according to claim 2,
wherein the optical transmission frame multiplex processing unit includes the multiplexing units, number of which depends on number of input lanes, with respect to each number of input lanes.

19. The multicarrier optical transmitter according to claim 2, further comprising a control unit,
wherein the control unit selects the multiplexing units connected to the transmission signal generation unit and the optical transmission unit respectively, depending on setting conditions.

20. The multicarrier optical transmitter according to claim 3, further comprising a control unit,
wherein the control unit selects the multiplexing units connected to the transmission signal generation unit and the optical transmission unit respectively, depending on setting conditions.
